(19) United States
(12) Patent Application Publication
(10) Pub. No.: US 2025/0183679 A1
(43) Pub. Date: Jun. 5, 2025

(54) POWER DISTRIBUTION METHOD FOR POWER SUPPLY AND CHARGING DEVICE

(71) Applicant: Delta Electronics (Shanghai) Co., Ltd., Shanghai (CN)

(72) Inventors: Tao WU, Shanghai (CN); Xiuju ZHANG, Shanghai (CN); Bingtao HU, Shanghai (CN)

(21) Appl. No.: 18/966,158

(22) Filed: Dec. 3, 2024

(30) Foreign Application Priority Data
Dec. 4, 2023 (CN) 202311649416.1

(51) Int. Cl. H02J 7/00

(52) U.S. Cl. CPC H02J 7/0019; H02J 7/00032; H02J 7/0047

(57) ABSTRACT

The present disclosure provides a power distribution method for a power supply and a charging device, and relates to the field of communication technology. The method includes: applied to a charger containing N (N≥2) output ports, sequentially taking each output port as a main output port according to a switching time interval during each switching cycle, priority distributing corresponding first transmission power that required to the main output port, and taking other output ports except for the main output port as secondary output ports, where the switching cycle includes M (M≥N) switching time intervals. The method of the present disclosure avoids a situation where output port power is too low resulting in an inability to charge a high-power load, and at the same time a dynamic power distribution of the output port of the charger improves an overall charging efficiency of connected loads.

### CROSS-REFERENCE TO RELATED APPLICATION

This application claims priority to Chinese Patent Application No. 202311649416.1, filed on Dec. 4, 2023, Which is hereby incorporated by reference in its entirety.

### TECHNICAL FIELD

Embodiments of the present disclosure relate to the field of communication technology and, in particular, to a power distribution method for a power supply and a charging device.

### BACKGROUND

A charger that complies with the USB PD3.1 protocol can achieve intelligent and fast charging with a changed output voltage within 5-48V by communicating with a to-be-charged device and adjusting an output power. However, for a multi-port charger, there may be a problem of how to distribute power between multiple ports.

There are mainly two methods to solve a power distribution problem of the multi-port charger. One is an average distribution method, which means that each output port outputs fixed power; however, when a rated charging power of the device is higher than an output capacity of a single output port, any output port of the changer in an average distribution design cannot provide power to the device. Another method is to pre-set a certain output port as a main output port, and remaining output ports are all secondary output ports, and the main output port outputs higher fixed power, while the secondary output ports output lower fixed power.

If in accordance with a method with fixed distribution power, the output port cannot fully utilize the output capacity of the charger. For example, when the rated charging power of the device is higher than the output capacity of any single output port, the charger in a main-and-secondary output ports design or the charger with an average power distribution can only rely on one output port to supply power to the device, and the remaining output ports cannot be fully utilized, resulting in a waste of the power output capacity of leisure output ports.

Purposes of the present disclosure is to fully utilize the output capacity of the charger by dynamically distributing the output power of each output port.

### SUMMARY

The present disclosure provides a power distribution method for a power supply and a charging device, so as to address drawbacks of the existing designs.

In a first aspect, the present disclosure provides a power distribution method for a power supply, applied to a charger containing N (N≥2) output ports, including:
sequentially taking each output port as a main output port according to a switching time interval during each switching cycle, priority distributing corresponding first transmission power that required to the main output port, and taking other output ports except for the main output port as secondary output ports, where the switching cycle includes M (M≥N) switching time intervals.

In one possible design, the method further includes: setting initial transmission power corresponding to each output port, and distributing power to each output port according to the initial transmission power during a first switching cycle of each charging process.

In one possible design, at an end moment of each switching time interval, obtaining and storing actual output power of a current main output port; and
determining the first transmission power of an output port corresponding to the current main output port during a next switching cycle according to the current actual output power.

In one possible design, the method further includes:
at the end moment of each switching cycle, judging whether the actual output power of each output port is less than an average output power; wherein the average output power is a ratio of total output power to an amount of connected loads of the charger;
if a judgment result is yes, evenly distributing the power to all the output ports, where a current switching cycle will be a last switching cycle; and
if the judgment result is no, entering a next switching cycle.

In one possible design, the determining the first transmission power of the output port corresponding to the current main output port during the next switching cycle according to the current actual output power, includes:
taking the current actual output power as the first transmission power of the output port corresponding to the current main output port during the next switching cycle; or,
taking a sum of the current actual output power and a preset power increment as the first transmission power of the output port corresponding to the current main output port during the next switching cycle.

In one possible design, the method further includes:
evenly distributing a power difference between total output power and the first transmission power to second transmission power to Nth transmission power; or,
distributing based on a ratio among the actual output power during a previous switching cycle of each load according to the power difference between the total output power and the first transmission power, and determining the second transmission power to the Nth transmission power.

In a second aspect, the present application provides a charging device, including:
output ports, where the number of the output ports is N (N≥2);
a controller, configured to sequentially take each output port as a main output port according to a switching time interval during each switching cycle, priority distribute corresponding first transmission power that required to the main output port, and take other output ports except for the main output port as secondary output ports, where the switching cycle includes M (M≥N) switching time intervals.

Preferably, the controller is specifically configured to:
set initial transmission power corresponding to each output port, and distribute power to each output port according to the initial transmission power during a first switching cycle of each charging process.

Preferably, the controller is specifically configured to:
at an end moment of each switching time interval, obtain and store actual output power of a current main output port; and
determine the first transmission power of an output port corresponding to the current main output port during a next switching cycle according to the current actual output power.

Furthermore, the controller is further configured to:
at the end moment of each switching cycle, judge whether the actual output power of each output port is less than an average output power; wherein the average output power is a ratio of total output power to an amount of connected loads of the charger;
if a judgment result is yes, evenly distribute the power to all the output ports, where a current switching cycle will be a last switching cycle; and
if the judgment result is no, enter a next switching cycle.

Furthermore, the controller is further configured to:
take the current actual output power as the first transmission power of the output port corresponding to the current main output port during the next switching cycle; or,
take a sum of the current actual output power and a preset power increment as the first transmission power of the output port corresponding to the current main output port during the next switching cycle.

Furthermore, the controller is further configured to:
evenly distributing a power difference between total output power and the first transmission power to second transmission power to Nth transmission power; or,
distribute based on a ratio among the actual output power during a previous switching cycle of each load according to the power difference between the total output power and the first transmission power, and determine the second transmission power to the Nth transmission power.

The present application provides the power distribution method for the power supply and the charging device by means of sequentially taking each output port as a main output port according to a switching time interval during each switching cycle, priority distributing corresponding first transmission power that required to the main output port, and taking other output ports except for the main output port as secondary output ports, where the number of switching time intervals in the switching cycle is not less than the number of output ports. Compared to the existing technologies, the present application achieves a dynamic adjustment of a transmission power according to load conditions, fully utilizing the output capacity of the charger, and improving charging efficiency.

### BRIEF DESCRIPTION OF DRAWINGS

In order to provide a clearer explanation of embodiments of the present disclosure or technical solutions in the prior art, a brief introduction will be made to accompanying drawings required in describing the embodiments or the prior art. It is obvious that the accompanying drawings in the following description are some embodiments of the present disclosure. For technicians in this field, other accompanying drawings can be obtained based on these accompanying drawings without creative labor.

FIG. 1 is an application scenario diagram of a power distribution for a power supply provided by the embodiment of the present disclosure.

FIG. 2 is a flowchart diagram I of a power distribution method for a power supply provided by an embodiment of the present disclosure.

FIG. 3 is a flowchart diagram II of a power distribution method for a power supply provided by an embodiment of the present disclosure.

FIG. 4 is a flowchart diagram III of a power distribution method for a power supply provided by the embodiment of the present disclosure.

FIG. 5 is a schematic diagram of a correspondence between each switching cycle and switching time intervals provided by an embodiment of the present application.

### DESCRIPTION OF EMBODIMENTS

Here, a detailed explanation of exemplary embodiments will be we provided, and examples are illustrated in the accompanying drawings. When the following description involves the accompanying drawings, unless otherwise indicated, same numbers in different drawings represent same or similar elements. Embodiments described in the following exemplary embodiments do not represent all embodiments consistent with the present disclosure. On the contrary, they are only examples of apparatus and methods that are consistent in some aspects of the present disclosure, rather than all embodiments. Based on the embodiments in the present disclosure, all other embodiments obtained by ordinary technicians in the art without creative labor fall within a protection scope of the present disclosure.

Firstly, relevant concepts or terms involved in the present disclosure will be explained:
the USB PD3.1 protocol: refers to the fast charging protocol standard launched by the USB-IF Association in 2021, Which further expands a power range on the basis of USB PD 3.0. In the USB PD 3.1 specification, original USB PD3.0 content is classified into a standard power range (SPR), and a maximum power remains unchanged at 100 W; at the same time, an extended power range (EPR) has been added, and the maximum power has been expanded from 100 W to 240 W. In EPR, various fixed voltage and adjustable voltage levels have been added to meet charging requirements of different devices.

For example, when a 60 W charger that complies with USB PD3.1 is connected to a to-be-charged laptop, the charger defaults to a 5V output and broadcasts through a USB pin, announcing a capacity of its maximum output power being 20V-3.25 A. After receiving a broadcast power, the to-be-charged laptop will give a handshake signal, and the charger will adjust an output voltage to 20V. Both the to-be-charged charger and laptop will control a charging current to not exceed 3.25 A. If a charging device is a PAD, as a charging power required by the PAD is less than the charging power of the laptop, the PAD will send a signal to inform the charger that only 15V-2 A is required. At this time, the charger will adjust the output to 15V, and both the charger and PAD will control the current to not exceed 2 A.

Existing multi-port chargers usually distribute the transmission power to each output port by evenly distributing total power, or fix a certain output port to output the maximum fixed transmission power, and enable remaining output ports output according to an average distribution method. These schemes distribute fixed output power to a respective output port, making it difficult to adapt to different loads. When a rated charging capacity of the load does not match an output capacity of the output port, it will lead to an inability to fully utilize the charging capacity of the charger, resulting in a waste of the output capacity of the charger.

Based on the above technical issues, an invention concept of the present disclosure is to periodically take each output port as a main output port in an early charging stage when the load has a high power demand, and take maximum transmission power of the main output port as transmission power; then, during a mid-charging period when the load has a general power demand, while periodically selecting the main output port, take actual output power of the main output port as the transmission power; finally, in a later charging stage when the load has a relatively small power demand, evenly distribute the transmission power of each charging port, so that an appropriate output power can be distributed to the output ports connected to different loads, thereby solving the technical issues mentioned above in the existing technology.

A specific application scenario of the present disclosure is as follows:

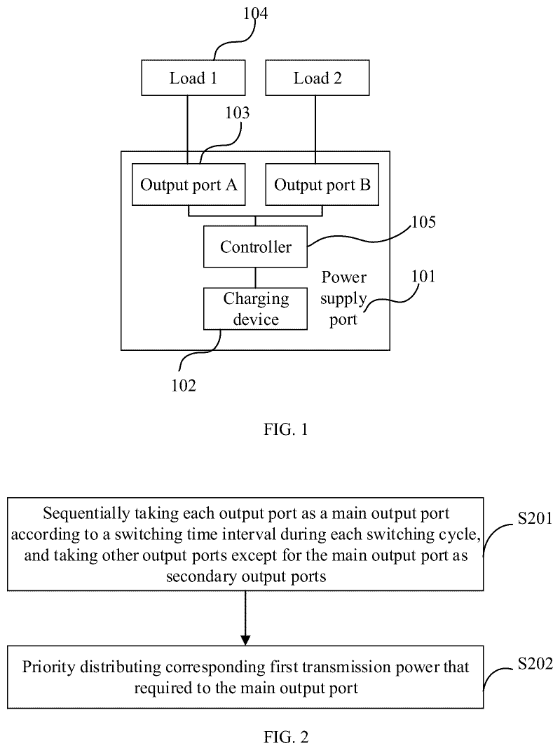

FIG. 1 is an application scenario diagram of a power distribution method for a power supply provided by an embodiment of the present disclosure. As shown in FIG. 1, a charging device 101 is provided with two output ports 103 connected to a load 104, that is, Output port A is connected to Load 1, and Output port B is connected to Load 2. Electricity is input through a power supply port 102 of the charger 101, and transmitted to Output port A and Output port B after being distributed and processed by a controller 105, and then transmitted to the connected Load 1 and Load 2.

A detailed explanation of the technical solution of the present disclosure and how to solve the above-mentioned technical issues will be provided below with reference to specific embodiments. The following specific embodiments can be combined with each other, and similar concepts or processes may not be repeated in some embodiments. The following will describe the embodiments of the present disclosure in conjunction with the accompanying drawings.

FIG. 2 is a flowchart diagram I of a power distribution method for a power supply provided by embodiment of the present disclosure. As shown in FIG. 2, the method includes:
S201, sequentially taking each output port as a main output port according to a switching time interval during each switching cycle, and taking other output ports except for the main output port as secondary output ports.

The number of the output ports is N (N≥2), and the switching cycle includes M (M≥N) switching time intervals.

Specifically, there are multiple output ports provided in a charger, such as two, three, and so on. As a voltage obtained by the charger is constant, total output power is also constant. In order to improve a fast charging efficiency, it needs to be processed based on a situation of the connected load when distributing power. The output ports that are not connected to the load do not need to be distributed with power, thereby increasing a power value distributed to the output ports that are connected to the load, and thus improving the charging efficiency of the connected load.

In order to achieve an overall fast charging effect, the output power of each output port is not fixed. Each output port is sequentially taken as the main output port outputting higher transmission power according to the switching time interval, while other output ports are secondary output ports outputting lower transmission power. The main output port changes over time, so that each connected load is distributed with a certain fast charging time, thereby avoiding a problem of a slow overall charging efficiency of all connected loads when one connected load occupies the output port with a certain fixed maximum power for a long time.
S202, priority distributing corresponding first transmission power that required to the main output port.

Specifically, due to a charging rule of the load being fast in an early stage and slow in a later stage, the load is unable to efficiently utilize all the power output by the charger in the later stage for charging. As a result, if distributable power is maintained on a certain load, it will not be used in the later stage for charging, but will not have an opportunity to be used by the remaining loads.

In order to improve the overall charging efficiency of multiple loads, the charger can sequentially perform fast charging according to a load situation, that is, provide maximum output power to one of the output ports during a certain period, provide minimum working power that meets a load charging condition to the other output ports, provide the maximum output power to a next output port in a next period, and provide the minimum working power that meets the load charging condition to the other output ports (including the output port that was previously provided with the maximum output power), thereby avoiding one certain load from occupying the output port with higher output power for a long time, resulting in a slower overall charging speed for multiple loads.

The first transmission power of the charger corresponding to the load is the highest value of the transmission power provided for the load; secondary transmission powers corresponding to the outputs of the remaining loads are second transmission power to Nth transmission power corresponding to the charger. The first transmission power is greater than any secondary transmission powers. The second transmission power to the Nth transmission power can be the same or different, that is, the secondary transmission power of each secondary output port can be evenly distributed according to a power difference between the total output power and the first transmission power, or distributed according to a ratio among the actual output power during a previous switching cycle of each load.

The main output port is taken as a priority distribution object for the transmission power, which enables the power distribution to be switched following a switching among the main and secondary output ports, and then distributable transmission power is sequentially distributed to each output port in each switching cycle, thereby achieving the overall fast charging effect of multiple output ports in one charger.

The method provided by this embodiment, by means of sequentially taking each output port as the main output port to transmit the corresponding first transmission power according to the switching time interval, and taking other output ports except for the main output port as the secondary output ports to transmit the corresponding second transmission power to Nth transmission power, achieves means of distributing the output power of each output port during a fast charging process, achieves a dynamic distribution of the output port power of the charger, so that each connected load can enjoy a fast charging period as the main output port, power transmission functions of each output port are fully utilized, and the overall charging efficiency of connected loads is improved.

A detailed explanation of a power distribution method for a power supply of the present disclosure will be provided below in combination with a specific embodiment.

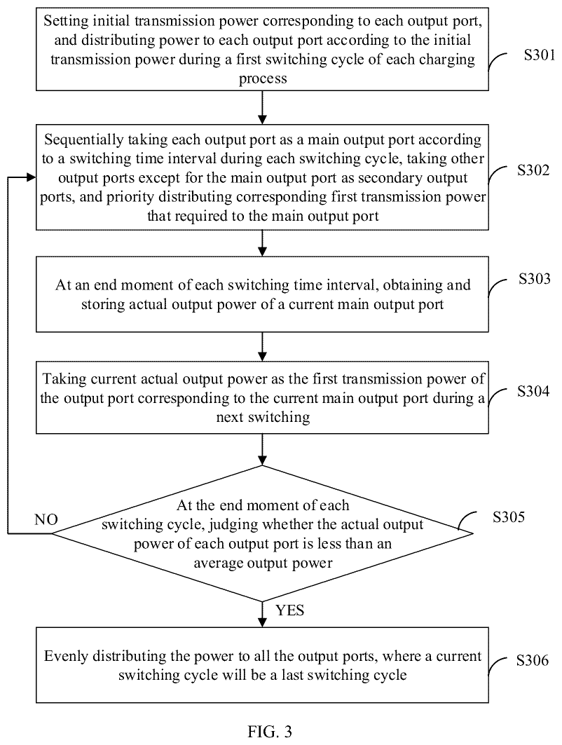

FIG. 3 is a flowchart diagram II of a power distribution method for a power supply provided by embodiment of the present disclosure. As shown in FIG. 2, the method includes:
S301, setting initial transmission power corresponding to each output port, and distributing power to each output port according to the initial transmission power during a first switching cycle of each charging process.

Specifically, when there are multiple output ports provided in a charger, in order to avoid a situation where output power of any output port is too low to supply power to a load, it is necessary to obtain total output power of the charger and minimum working power of each connected load in advance, in order to distribute output power of the output port reasonably.

The minimum working power is a fixed power value of the load as an operating device. If the output power of the charger is less than this minimum working power, it cannot be charged by the charger.

Due to a fact that the minimum working power is the minimum charging power for the connected load, which thus corresponds to second transmission power to Nth transmission power on the charger, so that the charger can distribute the power of the output ports based on the second transmission power to the Nth transmission power.
S302, sequentially taking each output port as a main output port according to a switching time interval during each switching cycle, taking other output ports except for the main output port as secondary output ports, and priority distributing corresponding first transmission power that required to the main output port.

The first transmission power corresponding to each output port is a power difference between total output power and secondary transmission power corresponding to the other output ports.

Specifically, after obtaining the secondary transmission power corresponding to each output port, the first transmission power of that output port is obtained by calculating a difference between the total output power and the secondary transmission powers of the other output ports.

Taking the case of two output ports as an example, for a charger with the total output power of 60 W, Load 1 and Load 2 are connected to Output port A and Output port B respectively. The minimum working power of Load 1 is 20 W, and the minimum working power of Load 2 is 30 W. Therefore, the second transmission power of Output port A corresponding to the charger is 20 W, the first transmission power is 60 W-30 W=30 W, the second transmission power of Output port B is 30 W, and the first transmission power is 60 W-20 W=40 W.
S303, at an end moment of each switching time interval, obtaining and storing actual output power of a current main output port.

Specifically, as a connection period for the load that connected to the charger extends, the amount of electricity stored in the load gradually increases, and a voltage difference with the charger gradually decreases. At this time, the load will obtain power from the charger according to actual demands. If the charger still distributes power according to the first transmission power and the second transmission power to the Nth transmission power in an early charging stage, part of power will not be drained and wasted. Therefore, when the actual output power of the load connected to the main output port decreases, it can be distributed according to the actual output power of the load. Therefore, it is necessary to obtain the actual output power of the load at the beginning and end of the switching time interval to determine whether the actual output power has decreased, which can thus be used to determine the power distribution method for a next cycle.
S304, taking current actual output power as the first transmission power of the output port corresponding to the current main output port during a next switching cycle.

Specifically, after setting the transmission power of the main output port to the actual output power, a power distribution processing also needs to be carried out according to a method of periodic distributing the main output port. At the end moment of the switching time interval, any of the secondary output ports will be selected as a new main output port, and the actual output power corresponding to this main output port should be output.

The transmission power of the main output port is set to the actual output power of the output port, and the power difference between the total output power and the first transmission power is evenly distributed as the second transmission power to the Nth transmission power, so as to increase the output power of other secondary output ports, thereby improving an overall actual output power output of the load and improving the overall charging efficiency of the load.

Taking the case of two output ports as an example, for a charger with the total output power of 60 W, Load 1 and Load 2 are connected to Output port A and Output port B respectively. The actual output power of Load 1 is 30 W, and the actual output power of Load 2 is 45 W. When Output port A is the main output port, the transmission power of Output port A corresponding to the charger is set to the actual output power of 30 W. At this time, the transmission power of Output port B is set to 60 W-30 W=30 W, so as to meet charging demands of Load 1 and improve the charging efficiency of Load 2.
S305, at the end moment of each switching cycle, judging whether the actual output power of each output port is less than an average output power; if so, executing S306, if not, entering a next switching cycle.

The average output power is a ratio of the total output power to an amount of connected loads of the charger.

Specifically, as a charging time increases, when the actual output powers of both output ports are less than the average output power of the charger, both output ports simultaneously transmit the average output power, which can meet the load demand without requiring to switch main and secondary roles of the two output ports during the switching time interval. Therefore, it is necessary to judge whether the actual output power is less than the average output power.
S306, evenly distributing the power to all the output ports, where a current switching cycle will be a last switching cycle.

Specifically, only when the actual output powers when both two output ports being the main output ports are not greater than the average output power, can they all switch to the average output power. When the actual output power of any output port is greater than the average output power, it is still necessary to output in a method that outputs according to the actual output power being the transmission power, so that the load larger than the average output power can be charged with relatively larger power, thereby improving the charging efficiency of the load.

The method provided by this embodiment, by means of setting the initial transmission power corresponding to each output port, and distributing the power to each output port according to the initial transmission power during the first switching cycle of each charging process; sequentially taking each output port as the main output port according to the switching time interval during each switching cycle, and taking the other output ports except for the main output port as the secondary output ports, and priority distributing the corresponding first transmission power that required to the main output port, the periodic switching of the situation where each output port takes the actual output power as the transmission power is achieved, thereby improving the power distribution of the secondary output port and improving the charging efficiency of the load connected with the secondary output port, and ensuring that switching different output ports as the main output port does not affect a normal charging status of other secondary output ports.

By means of obtaining and storing the actual output power of the current main output at the end moment of each switching time interval; and taking the current actual output power as the first transmission power of the output port corresponding to the current main output port during the next switching cycle, a function that pre-determines the transmission power corresponding to the next main output port after a periodic switching of the main and secondary output ports among different output ports is achieved.

By means of judging whether the actual output power of each output port is less than the average output power at the end moment of each switching cycle; if so, evenly distributing the power to all the output ports, where the current switching cycle will be the last switching cycle; if not, entering the next switching cycle, a judgment in the later charging stage is realized, thereby setting the transmission power of each output port as the average output power according a result of all the actual output powers being less than the average output power, so as to achieve a multi-load synchronous fast charging.

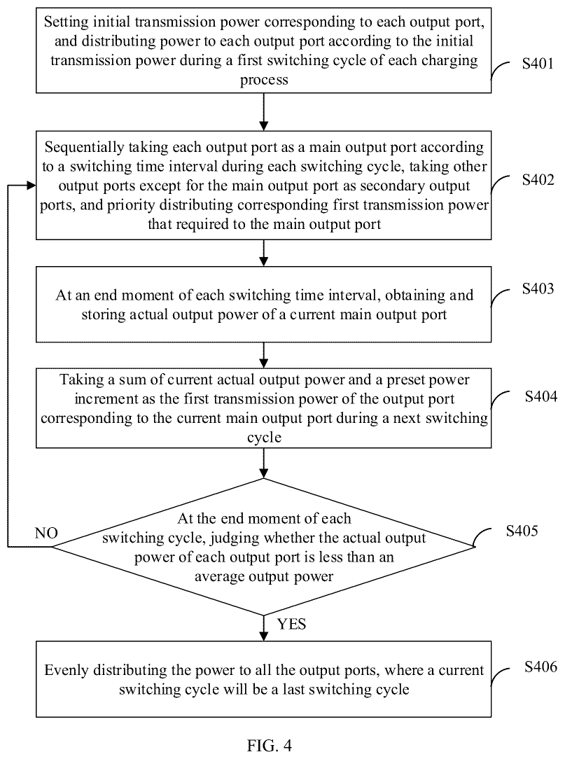

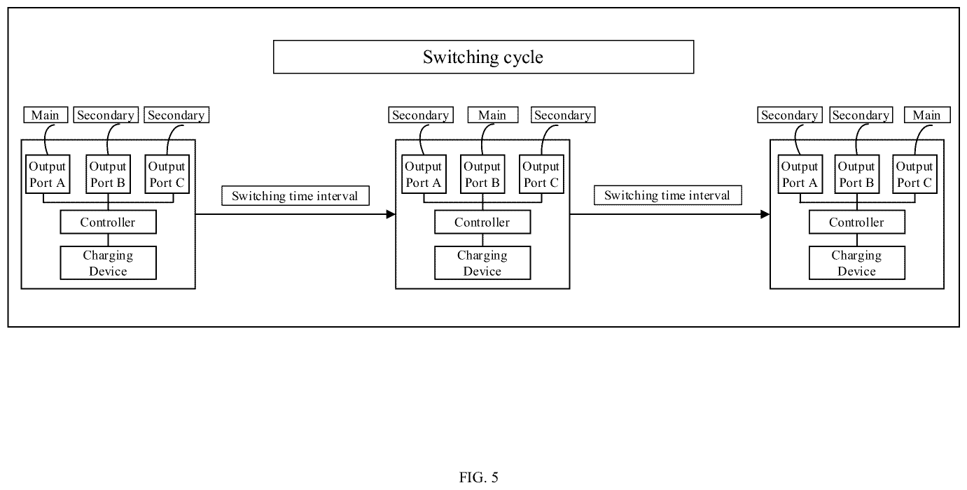

FIG. 4 is a flowchart diagram III of a power distribution method for a power supply provided by an embodiment of the present disclosure. As shown in FIG. 4, the method includes:
S401, setting initial transmission power corresponding to each output port, and distributing power to each output port according to the initial transmission power during a first switching cycle of each charging process.
S402, sequentially taking each output port as a main output port according to a switching time interval during each switching cycle, taking other output ports except for the main output port as secondary output ports, and priority distributing corresponding first transmission power that required to the main output port.
S403, at an end moment of each switching time interval, obtaining and storing actual output power of a current main output port.

Specific implementation of S401-S403 is similar to that of S301-S303, and this embodiment will not elaborate here.
S404, taking a sum of current actual output power and a preset power increment as the first transmission power of the output port corresponding to the current main output port during a next switching cycle.

Specifically, a distribution is carried out according to a ratio among the actual output power during a last switching cycle of each load, second transmission power to Nth transmission power are determined, a distributable preset power increment can be obtained by subtracting from the total output power; after distributing to any output port, the preset power increment is combined with any one of the second transmission power to the Nth transmission power of that output port to obtain the corresponding first transmission power of that output port.

Taking the case of two output ports as an example, for a charger with the total output power of 60 W, Load 1 and Load 2 are connected to Output port A and Output port B respectively. The minimum working power of Load 1 is 20 W, and the minimum working power of Load 2 is 30 W. Therefore, the second transmission power of the Output port A corresponding to the charger is 20 W, and the second transmission power of Output port B is 30 W, then the distributable power is 60 W-20 W-30 W=10 W. Therefore, the first transmission power of the Output port A corresponding to the charger is 30 W, and the first transmission power of Output port B is 40 W.

Due to a gradual decreasing of required voltage of the load during a cyclic switching of the main output port, it is required to monitor when the load enters a mid-charging cycle. Therefore, it is necessary to obtain the actual output power of the output port after switching at the end moment of each switching cycle.
S405, at the end moment of each switching cycle, judging whether the actual output power of each output port is less than an average output power; if so, executing S406; if not, entering the next switching cycle.
S406, evenly distributing the power to all the output ports, where a current switching cycle will be a last switching cycle.

The specific implementation of S405-S406 is similar to that of S305-S306, and this embodiment will not elaborate here.

The method provided in this embodiment, by means of taking the sum of the current actual output power and the preset power increment as the first transmission power of the output port corresponding to the current main output port during the next switching cycle, a function that pre-determines the transmission power corresponding to the next main output port after a periodic switching of the main and secondary output ports among different output ports is achieved.

FIG. 5 shows a schematic diagram of a correspondence between each switching cycle and switching time intervals provided by an embodiment of the present application. As shown in FIG. 5, taking the case of a charger with three output ports as an example, Output port A, Output port B and Output port C are sequentially taken as a main output port according to two switching time intervals included in one switching cycle. Where, FIG. 5 represents only a simple case; specifically, when there are N output ports (N≥2), (N−1) switching time intervals may be included in each switching cycle period.

An embodiment of the present disclosure also provides a charging device, and the device includes:
output ports, where the number of the output ports is N (N≥2);
a controller, configured to sequentially take each output port as a main output port according to a switching time interval during each switching cycle, priority distribute corresponding first transmission power that required to the main output port, and take other output ports except for the main output port as secondary output ports, where the switching cycle includes M (M≥N) switching time intervals.

Preferably, the controller is specifically configured to:
set initial transmission power corresponding to each output port, and distribute power to each output port according to the initial transmission power during a first switching cycle of each charging process.

Preferably, the controller is specifically configured to:
at an end moment of each switching time interval, obtain and store actual output power of a current main output port; and
determine the first transmission power of an output port corresponding to the current main output port during a next switching cycle according to the current actual output power.

Furthermore, the controller is further configured to:
at the end moment of each switching cycle, judge whether the actual output power of each output port is less than an average output power; wherein the average output power is a ratio of total output power to an amount of connected loads of the charger;
if a judgment result is yes, evenly distribute the power to all the output ports, where a current switching cycle will be a last switching cycle; and
if the judgment result is no, enter a next switching cycle.

Furthermore, the controller is further configured to:
take the current actual output power as the first transmission power of the output port corresponding to the current main output port during the next switching cycle; or,
take a sum of the current actual output power and a preset power increment as the first transmission power of the output port corresponding to the current main output port during the next switching cycle.

Furthermore, the controller is further configured to:
evenly distribute a power difference between total output power and the first transmission power to second transmission power to Nth transmission power; or,
distribute based on a ratio among the actual output power during a previous switching cycle of each load according to the power difference between the total output power and the first transmission power, and determine the second transmission power to the Nth transmission power.

The charging device provided by this embodiment can execute the power distribution method for the power supply of the above embodiment, and its implementation principle and technical effect are similar. This embodiment will not elaborate here.

The embodiments of the present disclosure can divide functional modules of electronic devices or main control devices according to the above method examples. For example, each functional module can be divided according to respective function, and two or more functions can be integrated into one processing unit. The integrated units mentioned above can be implemented in hardware, and can also be implemented in software functional modules. It should be noted that, a division of modules in the embodiments of the present disclosure is illustrative and only serves as a logical function division. In actual implementation, there may be other division methods.

In the specific implementation of the charging device mentioned above, each module can be implemented as a processor, and the processor can execute computer execution instructions stored in a memory, enabling the processor to execute the power distribution method for the power supply mentioned above.

An embodiment of the present disclosure also provides a fast charging charger, including:
a charger body, at least one processor and a memory;
where the processor is electrically connected to the charger body and the memory.

In a specific implementation process, the at least one processor executes computer execution instructions stored in the memory, so that the at least one processor executes the power distribution method for the power supply executed on the fast charging charger side as described above.

The specific implementation process of the processor can be found in the above method embodiment, implementation principle and technical effect of which are similar, and this embodiment will not elaborate here.

In the above embodiments, it should be understood that the processor can be a central processing unit (CPU), other general-purpose processors, a digital signal process (DSP), an application specific integrated circuit (ASIC), and the like. The general-purpose processor can be a microprocessor or any conventional processor. Steps of the methods disclosed in combination with the disclosure can be directly reflected in an implementation of executing by a hardware processor, or in the implementation of combining hardware and software modules in the processor.

The memory may include a high-speed RAM memory, as well as a non-volatile storage NVM, such as at least one disk storage.

Solutions provided by the embodiments of the present disclosure are introduced above with reference to the functions implemented by the electronic devices and the main control devices. It can be understood that, the electronic devices or control devices include hardware structures and/or software modules corresponding to the execution of each function in order to achieve the above functions. In combination with units and algorithm steps of examples described in the disclosed embodiments of the present disclosure, the embodiments can be implemented in a form of hardware or a combination of hardware and computer software. Whether a certain function is executed in a hardware mode or the mode that computer software drives hardware depends on specific applications and design constraints of the technical solution. Technicians in this field may use different methods for each specific application, so as to implement the described functions, but such implementation should not be considered beyond a scope of the technical solution of the embodiments of the present disclosure.

Finally, it should be noted that the above embodiments are only used to illustrate the technical solution of the present disclosure, and not to limit it; although the present disclosure has been described in detail with reference to the aforementioned embodiments, technicians in this field should understand that they can still modify the technical solutions recorded in the aforementioned embodiments, or equivalently replace some or all of the technical features; and these modifications or replacements do not make an essence of the corresponding technical solutions deviate from the scope of the technical solutions of various embodiments of the present disclosure.

What is claimed is:

1. A power distribution method for a power supply, applied to a charger containing N (N≥2) output ports, comprising:
sequentially taking each output port as a main output port according to a switching time interval during each switching cycle, priority distributing corresponding first transmission power that required to the main output port, and taking other output ports except for the main output port as secondary output ports, wherein the switching cycle comprises M (M≥N) switching time intervals.

2. The method according to claim 1, comprising:
setting initial transmission power corresponding to each output port, and distributing power to each output port according to the initial transmission power during a first switching cycle of each charging process.

3. The method according to claim 1, comprising:
at an end moment of each switching time interval, obtaining and storing actual output power of a current main output port; and
determining the first transmission power of an output port corresponding to the current main output port during a next switching cycle according to the current actual output power.

4. The method according to claim 3, further comprising:
at the end moment of each switching cycle, judging whether the actual output power of each output port is less than an average output power; wherein the average output power is a ratio of total output power to an amount of connected loads;
if a judgment result is yes, evenly distributing the power to all the output ports, wherein a current switching cycle will be a last switching cycle; and
if the judgment result is no, entering a next switching cycle.

5. The method according to claim 3, wherein the determining the first transmission power of the output port corresponding to the current main output port during the next switching cycle according to the current actual output power, comprises:
taking the current actual output power as the first transmission power of the output port corresponding to the current main output port during the next switching cycle.

6. The method according to claim 3, wherein the determining the first transmission power of the output port corresponding to the current main output port during the next switching cycle according to the current actual output power, comprises:
taking a sum of the current actual output power and a preset power increment as the first transmission power of the output port corresponding to the current main output port during the next switching cycle.

7. The method according to claim 3, wherein further comprising:
evenly distributing a power difference between total output power and the first transmission power to second transmission power to Nth transmission power.

8. The method according to claim 3, wherein further comprising:
distributing based on a ratio among the actual output power during a previous switching cycle of each load according to the power difference between total output power and the first transmission power, and determining the second transmission power to the Nth transmission power.

9. A charging device, comprising:
output ports, wherein a number of the output ports is N (N≥2);
a controller, configured to sequentially take each output port as a main output port according to a switching time interval during each switching cycle, priority distribute corresponding first transmission power that required to the main output port, and take other output ports except for the main output port as secondary output ports, wherein the switching cycle comprises M (M≥N) switching time intervals.

10. The device according to claim 9, wherein the controller is further configured to:
set initial transmission power corresponding to each output port, and distribute power to each output port according to the initial transmission power during a first switching cycle of each charging process.

11. The device according to claim 9, wherein the controller is further configured to:
at an end moment of each switching time interval, obtain and store actual output power of a current main output port; and
determine the first transmission power of an output port corresponding to the current main output port during a next switching cycle according to the current actual output power.

12. The device according to claim 11, wherein the controller is further configured to:
at the end moment of each switching cycle, judge whether the actual output power of each output port is less than an average output power; wherein the average output power is a ratio of total output power to an amount of connected loads;
if a judgment result is yes, evenly distribute the power to all the output ports, wherein a current switching cycle will be a last switching cycle; and
if the judgment result is no, enter a next switching cycle.

13. The device according to claim 9, wherein the controller is further configured to:
take the current actual output power as the first transmission power of the output port corresponding to the current main output port during the next switching cycle.

14. The device according to claim 9, wherein the controller is further configured to:
take a sum of the current actual output power and a preset power increment as the first transmission power of the output port corresponding to the current main output port during the next switching cycle.

15. The device according to claim 11, wherein the controller is further configured to:
evenly distribute a power difference between total output power and the first transmission power to second transmission power to Nth transmission power.

16. The device according to claim 11, wherein the controller is further configured to:
distribute based on a ratio among the actual output power during a previous switching cycle of each load according to the power difference between total output power and the first transmission power, and determine the second transmission power to the Nth transmission power.

17. A fast charging charger, comprising:
a charger body, at least one processor and a memory;
wherein the charging body comprises N (N≥2) output ports, the at least one processor is electrically connected to the charger body and the memory;
and the at least one processor executes computer execution instructions stored in the memory, enables the at least one processor to:
sequentially taking each output port as a main output port according to a switching time interval during each switching cycle, priority distributing corresponding first transmission power that required to the main output port, and taking other output ports except for the main output port as secondary output ports, wherein the switching cycle comprises M (M≥N) switching time intervals.

18. The charger according to claim 17, wherein the at least one processor is further configured to:
set initial transmission power corresponding to each output port, and distribute power to each output port according to the initial transmission power during a first switching cycle of each charging process.

19. The charger according to claim 17, wherein the at least one processor is further configured to:
at an end moment of each switching time interval, obtain and store actual output power of a current main output port; and
determine the first transmission power of an output port corresponding to the current main output port during a next switching cycle according to the current actual output power.

20. The charger according to claim 19, wherein the at least one processor is further configured to:
at the end moment of each switching cycle, judge whether the actual output power of each output port is less than an average output power; wherein the average output power is a ratio of total output power to an amount of connected loads;
if a judgment result is yes, evenly distribute the power to all the output ports, wherein a current switching cycle will be a last switching cycle; and
if the judgment result is no, enter a next switching cycle.
